(19) United States
(12) Patent Application Publication
(10) Pub. No.: US 2025/0341423 A1
(43) Pub. Date: Nov. 6, 2025

(54) LINEAR SHAPED INCIDENT SIGNAL FOR RAMAN SPECTROSCOPY

(71) Applicant: Thermo Scientific Portable Analytical Instruments Inc., Tewsksbury, MA (US)

(72) Inventor: Audrey Brand, Cambridge, MA (US)

(21) Appl. No.: 19/198,522

(22) Filed: May 5, 2025

Related U.S. Application Data
(60) Provisional application No. 63/643,240, filed on May 6, 2024.

(51) Int. Cl. G01J 3/44; G01N 21/65

(52) U.S. Cl. CPC G01J 3/4412; G01N 21/65; G01N 2201/0633; G01N 2201/0636

(57) ABSTRACT

Systems and methods for obtaining a Raman signal from a sample. One example provides an optical analysis system including a light source generating an excitation light, wherein the excitation light is collimated light having a first shape, an optical component configured to redirect the excitation light as a first light beam, and a focusing component configured to redirect the first light beam as a second light beam. The second light beam interrogates the sample at a predetermined distance from the focusing component in a linear shape.

### CROSS REFERENCE TO RELATED APPLICATIONS

The present application claims priority to U.S. Provisional Application No. 63/643,240, which was filed on May 6, 2024, and which is hereby incorporated by reference in its entirety.

### FIELD

Examples described herein generally relate to systems and methods for conducting optical material analysis, such as Raman spectroscopy.

### BACKGROUND

Raman spectroscopy is an effective tool for identifying and characterizing various sample compounds and substances. In Raman spectroscopy, light, typically from a laser and of a known wavelength (also referred to herein as an incident signal), is directed at a sample compound or substance (referred to herein as a “sample”). The laser photons (also sometimes referred to as a Raman pump) inelastically scatter, or “Raman scatter,” off the molecules in the sample and experience wavelength shifting to new frequencies given by bond vibrational frequencies present in the molecules of the sample. The precise nature of this wavelength shifting depends upon the materials present in the sample. A unique wavelength signature (typically called the Raman signature) is produced by each sample. This unique Raman signature permits the sample to be identified and characterized. More specifically, the spectrum of light returning from the sample is analyzed with a spectrometer to identify the Raman-induced wavelength shifting from the Raman pump light, and this wavelength signature is compared (e.g., by a computing device) with a library of known Raman signatures to identify characteristics of the sample.

### SUMMARY

The incident signal is typically delivered as a Gaussian spot on the sample. Some samples utilized in Raman spectroscopy, however, have an uneven substrate distribution, such as, for example a Surface-Enhanced Raman Spectroscopy (SERS) chip. These uneven substrates may result in irregular distribution of the incident signal on the sample resulting in “hotspots” or a weak Raman signal. When process-related variations are non-uniformly distributed across the SERS chip surface, interrogating the sample with a circular beam can result in an all-or-nothing situation where the measurement spot either encloses or misses the best region. Relocating a circular beam which has missed the region of sample with best signal can be overcome through complicated mechanical operations that include relocating the beam, and searching across the area in a spiral, linear raster, or random pattern.

To solve this and other issues, examples described herein provide an incident signal with a linear shape. Changing the shape of the incident signal to be more effectively distributed across the sample enables a more robust result. When more of the sample (substrate) is covered by the incident signal, the resulting Raman signal is maximized. Moreover, mechanically rotating the incident signal with a linear shape (e.g., by at least 180 degrees) can effectively cover the sample surface with incident signal in a simple mechanical operation that is inexpensive and easy to achieve (e.g., as compared to linear translation of the beam). A more accurate Raman signal results in a more complete picture of the sample being analyzed.

For example, an attachment is described herein that may be used with an optical analysis system (e.g., a Raman probe) to provide a linear shaped incident signal. The attachment may be used with a Raman probe configured to output an incident signal and detect a Raman signal (e.g., along the same optical path as the incident signal). When used with the attachment described herein, a focusing lens (e.g., a spherical lens) of the Raman probe is removed, such that the Raman probe outputs collimated light. Such a Raman probe with the focusing lens removed may be referred to herein as a “lensless” Raman probe.

The attachment for the lensless Raman probe includes an optics housing that includes a first opening for receiving the collimated excitation light from the lensless Raman probe. The optics housing defines a pathway for the received collimated light, wherein the excitation light received at the first opening is received at an optical component (e.g., a flat mirror) positioned within the optics housing, which redirects the collimated light along the pathway defined by the pathway as a first light beam. The first light beam is received by a focusing component positioned within the optics housing (e.g., a cylindrical focusing mirror, such as a concave mirror), which redirects the first light beam as a second (e.g., focused) light beam having a linear shape when interrogating the sample. The second light beam passes through a second opening of the optics housing to interrogate the sample.

Accordingly, the optical component and the focusing component may define an optical pathway in a zig-zag shape to effectively focus and reshape the collimated light output by the lensless Raman probe. The Raman scatter resulting from the provided linear incident signal may be detected by a detector within the lensless Raman probe wherein the detected scatter follows the same optical path as the incident signal (e.g., through the attachment from the second opening to the first opening along the defined optical pathway). Accordingly, the combination of the lensless Raman probe and the attachment may be referred to herein as a lensless linear probe. It should be understood, however, that examples described herein may be used with other types of Raman instruments and systems and may use other combinations of mirrors, lenses, filters, and the like to deliver a linear shaped incident signal to a sample.

As described herein, the linear shaped incident signal interrogates a more geographically diverse cross-section on the sample (as compared to using a Gaussian spot) while maintaining a similar overall interrogation area on the sample as a traditional Raman probe. Maintaining a similar area maintains Raman signal efficiency, which is dependent on spot size. At least a portion of the optical component, the focusing component, or both may be coated in, for example, a machined aluminum or precision molded plastic component depending on a desired application (e.g., wavelength being used, such as, for example, protected gold for infrared light). The optics housing may also include an optic flat at the second opening (the exit for the incident light) and one or more gaskets or other sealing mechanisms to make the attachment submersible.

Accordingly, in some aspects, the techniques described herein relate to an optical analysis system for obtaining a Raman signal from a sample, the optical analysis system including: a light source generating an excitation light, wherein the excitation light is collimated light; an optical component configured to redirect the excitation light as a first light beam; and a focusing component configured to redirect the first light beam as a second light beam wherein the second light beam interrogates the sample at a predetermined distance from the focusing component in a linear shape.

In some aspects, the techniques described herein relate to an attachment for an optical analysis system for obtaining a Raman signal from a sample, the attachment including: an optics housing including a first opening for receiving an excitation light from a light source, wherein the optics housing defines a pathway; an optical component positioned within the optics housing and configured to receive the excitation light as a collimated light and redirect the collimated light along the pathway as a first light beam; and a focusing component positioned within the optics housing and configured to receive the first light beam and redirect the first light beam as a second light beam along the pathway toward the sample, the second light beam having a linear shape, the optics housing further including a second opening, the second light beam passing through the second opening to interrogate to the sample.

There is no specific requirement that a system, method, or technique relating to Raman spectroscopy include all of the details characterized herein to obtain some benefit according to the present disclosure. Thus, the specific examples characterized herein are meant to be example applications of the techniques described and alternatives are possible.

### BRIEF DESCRIPTION OF THE DRAWINGS

Features and advantages of the present technology will become more apparent from the following detailed description of examples thereof taken in conjunction with the accompanying drawings in which:

FIG. 1 is a perspective view of an example spectroscopy system in use with a liquid sample container.

FIG. 2 is a block diagram of the spectroscopy system of FIG. 1.

FIG. 3 is a block diagram of an example controller component.

FIG. 4 is a perspective view of a spectroscopy system similar to that of FIG. 1

including an attachment for creating a linear shaped incident signal according to an aspect of the disclosure herein.

FIG. 5 is a schematic perspective view of the attachment of FIG. 4.

FIG. 6 is a cross-sectional view of the attachment of FIG. 4.

FIG. 7 is a cross-sectional view illustrating a shape of collimated light received via the attachment of FIG. 4.

FIG. 8 is an enlarged view of an example sample and a typical gaussian spot incident signal provided on the same.

FIG. 9 is an enlarged view of an example sample and a linear shaped incident signal provided on the same.

FIG. 10 illustrates a ray diagram of light traveling through the attachment of FIG. 4.

While the present technology is susceptible to various modifications and alternative forms, specific aspects have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

Unless otherwise defined, all technical and scientific terms used herein have the same meaning as commonly understood by one of ordinary skill in the art. In case of conflict, the present document, including definitions, will control. Example methods and systems are described below, although methods and systems similar or equivalent to those described herein may be used in practice or testing of the present disclosure. The systems, methods, and examples disclosed herein are illustrative only and not intended to be limiting.

The terms “comprise(s),” “include(s),” “having,” “has,” “may,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

As used herein, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The present disclosure is now described with reference to the drawings, wherein like reference numerals are used to refer to like elements throughout. In the following description, for purposes of explanation, numbers of specific details are set forth in order to provide an improved understanding of the present disclosure. It may be evident, however, that the systems and methods of the present disclosure may be practiced without one or more of these specific details. In other instances, well-known structures and devices are shown in block diagram form in order to facilitate describing the systems and methods of the present disclosure.

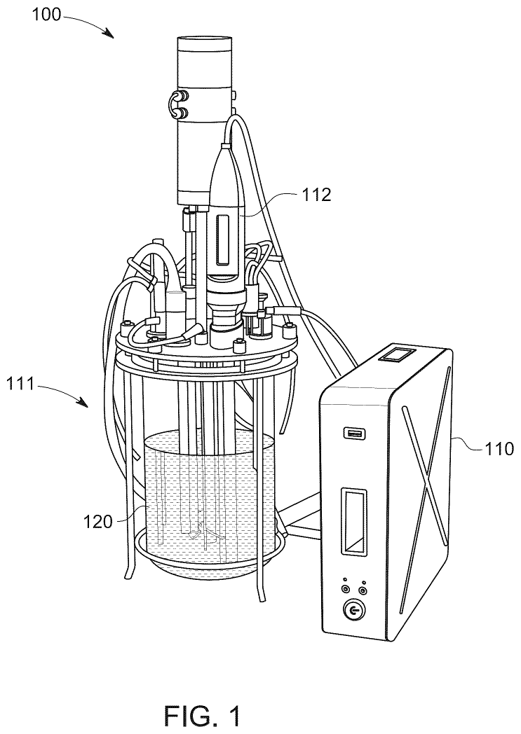

FIG. 1 is a perspective view of an example optical analysis system 100 in accordance with some aspects of the present disclosure. The optical analysis system 100 may be used to perform optical spectroscopy, such as, for example, Raman spectroscopy. As illustrated in FIG. 1, the optical analysis system 100 includes a controller component 110 and a probe component 112. A portion of the probe component 112 (for example, a probe head) is situated within a sample holder 111 such that the probe component 112 is positioned to project light onto a sample 120, as described below in more detail. The sample holder 111 may be, for example, a vat, a tank, a bioreactor, or some other storage unit for storing the sample 120. Other means of situating the probe component 112 to interact with a sample 120 may also be contemplated, as described herein. For example, it should be understood that the methods and systems described herein may be used to analyze various types of samples (including, for example, Surface-Enhanced Raman Spectroscopy (SERS) chips) and is not limited to analysis of liquid samples. Furthermore, the methods and systems described herein may be used with various types of Raman instruments and is not limited to probes. For example, the attachment described herein may be used with a bench mounted Raman instrument.

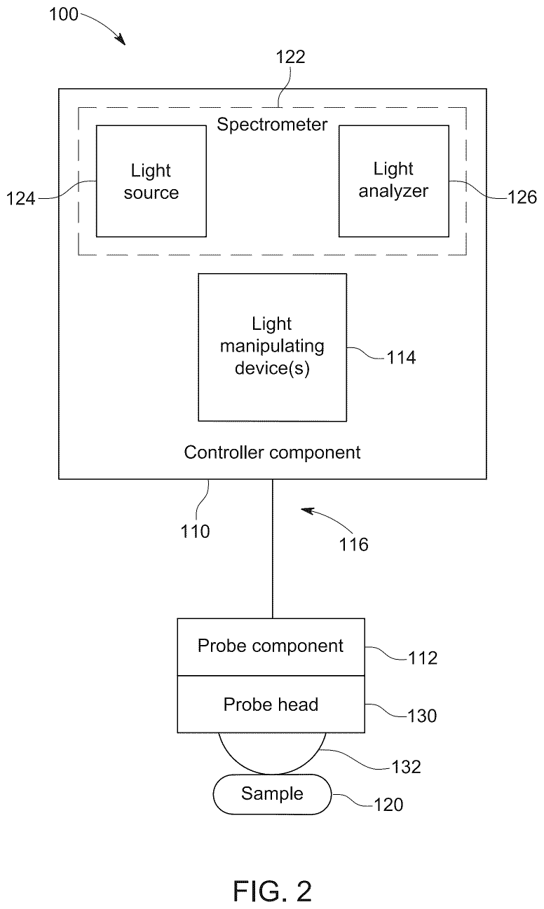

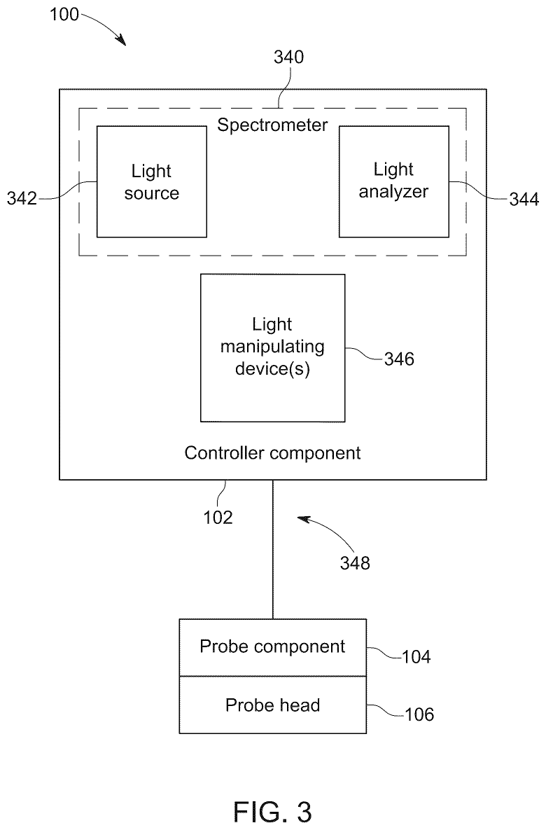

FIG. 2 is a schematic illustration of the example optical analysis system 100 of FIG. 1 in accordance with some aspects of the subject disclosure. The controller component 110 may include a spectrometer 122 including a light source 124 (e.g., a laser light source) and a light analyzer 126. The controller component 110 may also include one or more light manipulating devices 114 configured to receive laser light from the light source 124 and direct the laser light (e.g., finely focused) to the probe component 112. The controller component 110 may also include an electronic processor 300 and data storage device 302, as described with respect to FIG. 3.

The probe component 112 may be coupled to the controller component 110 via a fiber optic assembly 116 or other suitable light pipe. The light manipulating devices 114 are further configured to receive a Raman signal light from the fiber optic assembly 116 and direct the Raman signal light to the light analyzer 126. The light manipulating devices 114 may include one or more filters, reflectors, lens, or a combination thereof. For example, in some examples, a notch filter may direct laser light from the light source 124 toward a reflector that directs the laser light to a focusing lens that focuses and directs the laser light to a proximate end (i.e., proximate from a surface of the probe component 112 interfacing with the sample 120) of the fiber optic assembly 116. The directed laser light travels through the fiber optic assembly 116 to a distal end of the fiber optic assembly 116 positioned at a distal end of the probe component 112. In some examples, the light manipulating devices 114 include a collimating lens configured to direct Raman signal light received at the proximate end of the fiber optic assembly 116 through one or more filters (e.g., the notch filter) and to the light analyzer 126.

It should be understood that examples described herein may be used with various types of spectroscopy systems, including various types and configurations of Raman spectroscopy systems, and is not limited to any specific configuration or arrangement of light manipulating devices. In other words, any suitable arrangement of light manipulating devices could be used to direct excitation laser light to the fiber optic assembly, receive Raman signal light from the fiber optic assembly, and direct the received Raman signal light to the light analyzer 126 of the spectrometer 122.

In some examples, the probe component 112 (including at least a portion of the fiber optic assembly 116) is part of, or integrated with, the controller component 110. For example, the probe component 112 may be mechanically attached to a housing that houses the controller component 110. In some implementations, the probe component 112 is retractable, in whole or in part, allowing the optical analysis system 100 to be more compact in a probe-retracted configuration than in a probe-extended configuration. As an example, in a hand-held implementation, a housing of the optical analysis system 100 can house the probe component 112 in a retracted position such that the probe component 112 can be extended (e.g., in a stiletto knife manner, rotated or folded out into an extended position), detached from the retracted position, and reattached in an extended position, or other similar adjustable positions.

Also, in some examples, the probe component 112 can be flexibly connected to the controller component 110. For example, the probe component 112 may include a “goose-neck” type flexible portion, a pivot portion, a rotatable portion, or the like that allows the disposition of the probe component 112 relative to controller component 110 to be changed. For example, the probe component 112 may include a flexible portion, such as an elastomeric portion, to enable the probe component 112 to be employed in different positions relative to the controller component 110.

In some examples, the probe component 112 may be fixedly coupled with the controller component 110, may be integrated with the controller component 110, or may be removably coupled with the controller component 110. For example, in some examples, the controller component 110 includes one or more interfaces (e.g., integrated into a housing of the controller component 110) for receiving a probe component 112, such as, for example, using a snap-on, clamp-on, screw-on, slide-and-lock-on, or other type of coupling arrangement. Such interfaces may allow probe components 112 to be exchanged by “unplugging” one component and replacing it with a different component, which may be the same type of a probe component 112 or a different type of a probe component 112.

The probe component 112 includes a probe head 130 such as, for example, a probe head 130 enabling Raman spectrometry of a sample. Excitation laser light directed into the proximate end of the fiber optic assembly 116 exits the distal end of the fiber optic assembly 116 at an optical lens 132 of the probe head 130, which may be positioned at the distal end of the probe head 130. The probe head 130 may include a housing providing shielding and protecting the (or a portion of the) fiber optic assembly 116 positioned within the probe head 130. The housing of the probe head 130 may be sealed with the optical lens 132 to protect the fiber optic assembly 116 included in the probe head 130. In some examples, the optical lens 132 includes a spherical optical lens that serves as both an optical component and a sample interface. The spherical lens, which may also be referred to herein as a ball probe, may be used as a sampling interface for the analysis of many types of samples, such as, for example, solids, powders, slurries, suspensions, particles, vapors, liquids, and the like. The samples may be homogenous, heterogenous, or comprised of multiple phases.

Excitation light (e.g., laser light, also referred to herein as an incident signal) that is projected by the optical lens 132 onto the sample 120 causes the sample 120, in reaction to the excitation light, to emit a Raman signal light (e.g., effectively “glow”). Light emitted by the sample 120 (also referred to as Raman shifted light or emitted light or Raman signal light) at the effective focal length (e.g., at an effective focal point, which may be within an effective focal region) P (i.e., a Raman signal light) travels back through the same conical configuration (i.e., the same light path) to the surface of the probe head 130 where the original excitation light was emitted from. The effective focal length P is the location at which the light projected by the optical lens 132 intersects at approximately the same point or same region. As noted above, the Raman signal light is directed toward the light analyzer 126. In other words, light emitted from the probe head 130 initiates an analytical interrogation of the sample 120 (e.g., exciting atomic bonds of molecules in the sample 120) such that a Raman spectrum can be captured by the light analyzer 126 (e.g., including one or more detectors, such as, for example, one or more charged-coupled device (CCD) detectors) as a response to the interrogation of the sample 120. The Raman spectrum can be analyzed, for example, by the light analyzer 126 or by a separate component included in the controller component 110 or remote from the controller component 110. For example, the analysis of the Raman spectrum can be based on reference Raman spectra stored at controller component 110 or remote to but accessible to the controller component 110.

It should be understood that various configurations and arrangements of probe components 112 may be used with the examples described herein and various suitable probe components 112, or various configurations of probe components 112, may exist that emit excitation light and receive reflected light (e.g., scattered light) from a sample.

Referring now to FIG. 3, the controller component 110 may include an electronic processor 300, data storage device(s) 302, and an input/output (I/O) interface 304, in addition to the light source 124 and the light analyzer 126 that form the spectrometer 122. However, it should be understood that the controller component 110 may have additional or fewer components.

The controller component 110 is suitable for the application and setting, and can include, for example, multiple electronic processors, multiple I/O interfaces, multiple data storage devices, or combinations thereof. In some implementations, some or all of the components included in the controller component 110 may be attached to one or more mother boards and enclosed in a housing (e.g., including plastic, metal and/or other materials). In some implementations, some of these components may be fabricated onto a single system-on-a-chip, or SoC (e.g., an SoC may include one or more processing devices and one or more storage devices). Additionally, one or more of these components may be situated in a separate housing. For example, the electronic processor 300 may be situated in a first housing, while the data storage device(s) 302 are situated in a second housing communicatively coupled to the first housing.

As used herein, “processors” or “electronic processor” refers to any device(s) or portion(s) of a device that process electronic data from registers and/or memory to transform that electronic data that may be stored in registers and/or memory. The electronic processor 300 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices.

The data storage device 302 may include one or more local or remote memory devices such as random-access memory (RAM) devices (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some implementations, the data storage device 302 may include memory that shares a die with a processor. In such an implementation, the memory may be used as a cache memory and may include embedded dynamic random-access memory (eDRAM) or spin transfer torque magnetic random-access memory (STT-MRAM), for example. In some implementations, the data storage device 302 may include non-transitory computer readable media having instructions thereon that, when executed by one or more processors (e.g., the electronic processor 300), causes the controller component 110 to store various applications and data for performing one or more of the methods described herein or portions described herein. It should be understood that each method described herein may be implemented via one application or multiple applications and, in some examples, the data storage device 302 stores additional data in various configurations.

The I/O interface 304 of controller component 110 may include one or more communication chips, connectors, and/or other hardware and software to govern communications between the controller component 110 and other components. For example, the I/O interface 304 may include circuitry for managing wireless communications for the transfer of data to and from the controller component 110. In some implementations, the I/O interface 304 may include one or more antennas (e.g., one or more antenna arrays) for receipt and/or transmission of wire communications.

As noted above, the excitation light (i.e., incident signal) provided via the optical analysis system 100 may be delivered as a Gaussian spot on the sample. Some samples utilized in Raman spectroscopy, however, have an uneven substrate distribution, such as, for example a Surface-Enhanced Raman Spectroscopy (SERS) chip. SERS enhances Raman scattering through the use of rough or uneven surfaces (e.g., metal surfaces or other nanostructures). Such uneven substrates, however, may result in irregular distribution of the incident signal on the sample, which results in “hotspots” or a weak Raman signal. Furthermore, while rastering may be used to address uneven distribution of substrates on SERS chips or when probing other non-uniform services, such rastering requires mechanical movement (e.g., from a user or a mirror) that increases the cost and reduces the robustness of a probe. However, with process analytical technologies (PAT) there is a contrasting need for increasingly sensitive measurements in low-cost field devices. In addition, as probes are intended for ease of use within various field environments, a customer base of field devices may not know to test multiple spots of an uneven surface, such as, for example, through rastering.

Accordingly, to address this and other issues with existing Raman technology, examples described herein reshape the incident signal to deliver a linear shaped incident signal to the sample, which enhances perform of a Raman spectroscopy system on an uneven surface. As described in more detail below, an attachment can be used with a Raman probe as described above to reshape the incident signal. As described herein, the attachment receives collimated light and reshapes the collimated light into a linear shape for interrogating the sample. Accordingly, in some examples, the Raman probe described above is used with the described attachment with the optical lens 132 removed (or otherwise moved out of use) from the probe (which may be provided as a feature of the Raman probe). Accordingly, examples described herein may refer to the Raman probe or system used with the attachment as a “lensless” probe or system. It should be understood, however, that in some implementations the described attachment may be used with other probes or systems (including non-Raman probes or systems) configurable to output collimated light for receipt within the attachment described herein. Furthermore, in some examples, one or more optical components included in the attachment described herein may be configured to generate collimated light from light output via a Raman probe or system, such as the Raman probe described above. Accordingly, it should be understood that the examples described herein are not limiting and other configurations for reshaping a provided light into a linear shape may be used.

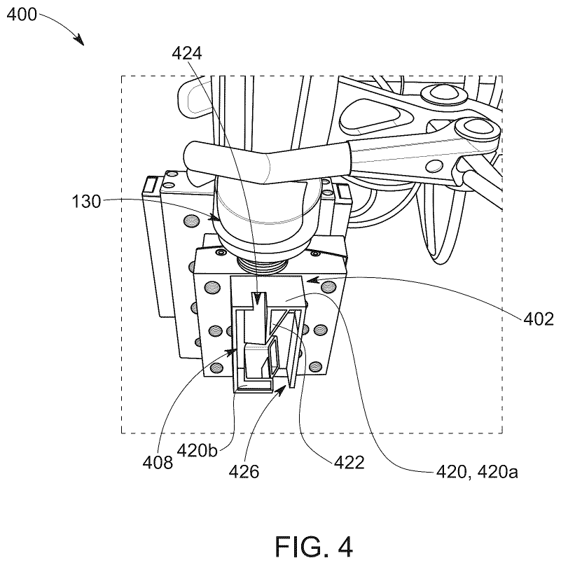

FIG. 4 is a perspective view of an optical analysis system 400 similar to the optical analysis system 100 of FIG. 1 including an attachment 402 for creating a linear shaped incident signal. The attachment 402 includes an optics housing 408. The optics housing 408 may include any number of exterior walls 420, including only one. Any number of interior walls 422 is also contemplated. A first opening 424 is formed in a first of the exterior walls 420a and a second opening 426 is formed in a second of the exterior walls 420b, which may be opposite the first of the exterior walls 420a. As illustrated in FIG. 4, when the attachment 402 is used with the system 100, the probe head 130 (with the optical lens 32 removed) is positioned to project light through the first opening 424. The attachment 402 may be used with the probe head 130 by positioning the attachment 402 in front to the probe head 130, coupling the attachment 402 to the probe head 130 or other portion of the Raman probe (e.g., through a threaded coupling, a friction-fit coupling, an adhesive coupling, or the like).

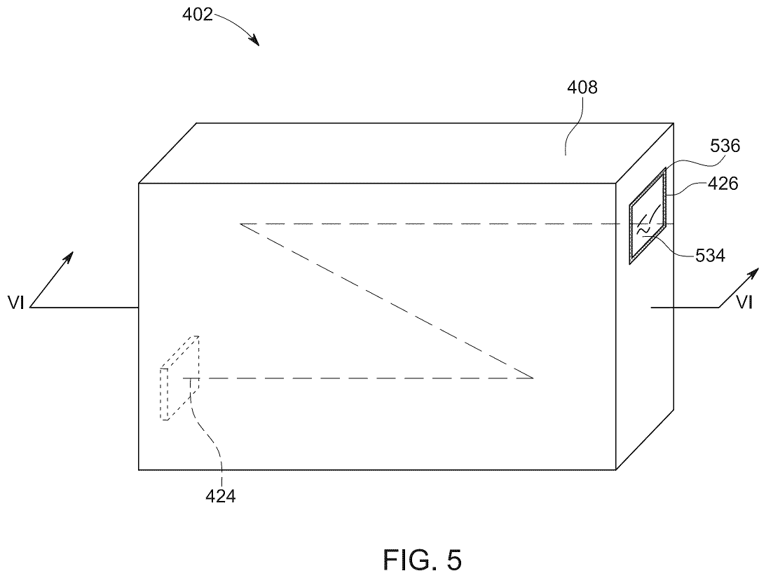

FIG. 5 is a schematic perspective view of the attachment 402 according to some aspects of the disclosure. As illustrated in FIG. 5, in some examples, the first opening 424, the second opening 426, or both the first opening 424 and the second opening 426 are closed from the environment (containing the sample) via a window 534 made of a non-refractive, or optically flat, material (e.g., sapphire or flat glass) and sealed with one or more gaskets 536. In this manner, at least a portion of the attachment 402 may be submersible (e.g., placed in a fluid or used in an autoclavable environment).

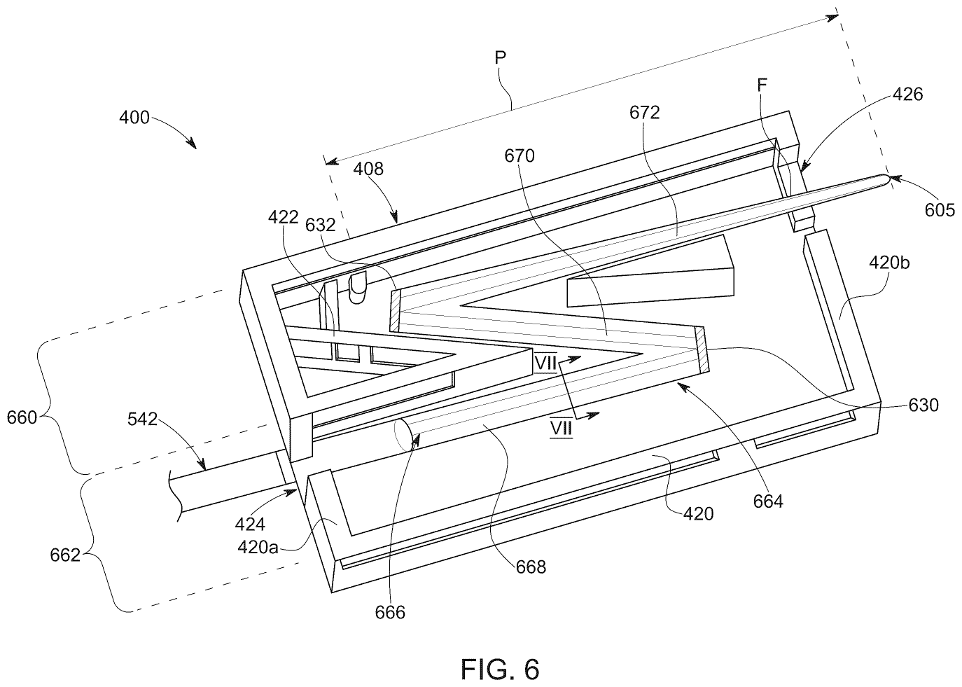

FIG. 6 is a cross-section taken along VI-VI of FIG. 5 illustrating an interior of the optics housing 408. As illustrated in FIG. 6, positioned within or otherwise supported by the optics housing 408 is an optical component 630 (also referred to herein as a redirecting component) and a focusing component 632. In some examples, the optical component 630 is a flat mirror and the focusing component 632 is a concave mirror. At least a portion of the optical component 630, the focusing component 632, or both may be constructed using machined aluminum or precision molded plastic. Further, at least a portion of the optical component 630, the focusing component 632, or both may be covered with a coating, and the composition of the coating may depend on the wavelengths being used to scan a sample. For example, protected gold may be used as the coating for infrared radiation (e.g., wavelengths between 780 nm and 1000 nm). The coating may be metal and may also be autoclavable.

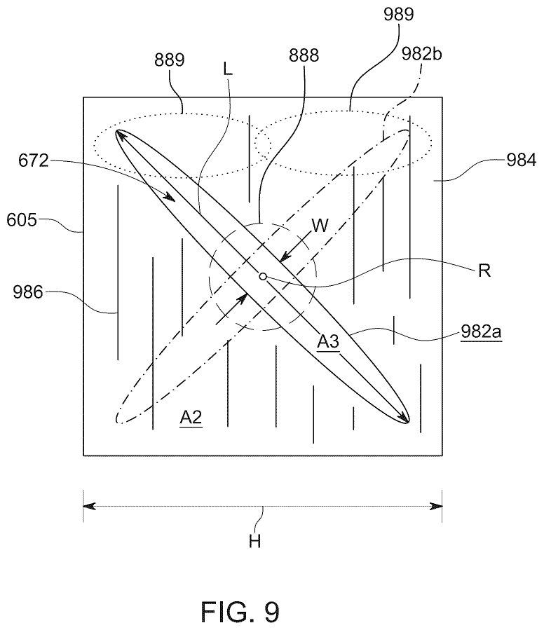

As illustrated in FIG. 6, interior walls 422 of the attachment 402 may at least partially separate the optics housing 408 into two sections: a first section 660 and a second section 662 (which may be coupled in various ways or molded together). The interior walls 422 may form a zigzag pathway 664 within the optics housing 408 extending from the first opening 424 (receiving light from a light source 542) to the second opening 426, where light is output for interrogating a sample 605, which may be positioned at a predetermined distance (denoted “P”) from the focusing component 632 that may also position the sample 605 spaced from the second opening 426. In some examples, the predetermined distance P is based on the sample 605 being analyzed and an effective focal length (denoted “F”) of the focusing component 632 (e.g., the concave mirror). The effective focal length F is a distance from the concave mirror at which the light reflected by the focusing component 632 intersects at approximately the same point or same region. The effective focal length F may range from 25 millimeters (mm) to 105 mm. In a non-limiting example, the effective focal length F is at the second opening 426. It should be understood, however, that the sample 605 may be located at any suitable distance from the focusing component 632 (such distance referred to herein as the predetermined distance P) at which a linear shape 982 (FIG. 9) forms, also known as astigmatism. This predetermined distance P may be beyond or further from the focusing component 632 than the effective focal length F. While the effective focal length F may appear to be a single point at which the light reflects from and the reflected light passes through, in practice the effective focal length F may be a region through which the reflected light passes.

During operation of the optical analysis system 400 with the attachment 402 installed, the light source 542 generates an excitation light 666, such as, for example, a laser light, as collimated light 668. The collimated light 668 is redirected by the optical component 630 (e.g., a flat mirror). In other words, the collimated light 668 is reflected and directed toward the focusing component 632 to define a first light beam 670. The first light beam 670 is redirected and reshaped by the focusing component 632 toward the sample 605. In other words, the first light beam 670 is focused by the focusing component 632 as a second (e.g., focused) light beam 672, which has a linear shape or profile.

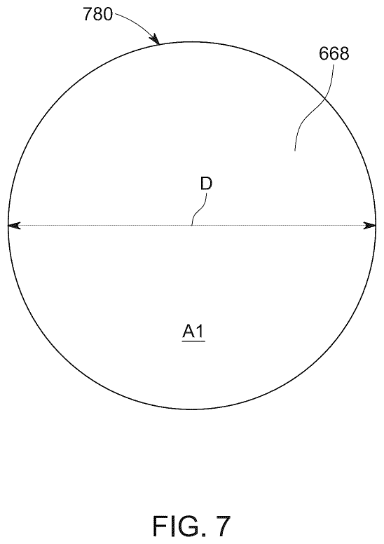

FIG. 7 is a cross-sectional view taken along line VII-VII of FIG. 6 illustrating a shape 780 of the collimated light 668. As illustrated in FIG. 6, the shape 780 may have a circular shape and defines a first area (denoted “A1”). The first area A1 may define a first dimension, or diameter in this case (denoted “D”), that ranges from 2 millimeters (mm) to 20 mm. In one non-limiting example, the diameter D is equal to 4 mm.

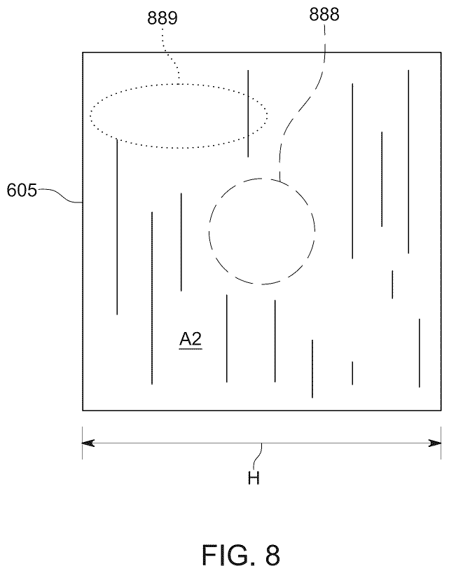

Turning to FIG. 8, an enlarged view of the sample 605 is illustrated. The sample 605 defines a second area A2 (denoted “A2”). The sample 605 may be a polygon, such as a square having four equal side dimensions (denoted “H”) that range from 3 mm to 5 mm. In one non-limiting example the side dimension H is equal to 4 mm.

A typical gaussian spot 888 is illustrated in dashed line in FIG. 8. The sample 605 includes a region 889 representative of a region of interest of the sample 605 (e.g., where optimal readings are available or where a substance of interest is located). While illustrated in the upper right-hand corner, it should be understood that the region 889 can be located anywhere on the sample 605. In this particular example, producing a typical gaussian spot 888 does not enable an overlap of the region 889 and the gaussian spot 888 (e.g., without repositioning). Accordingly, reshaping of the collimated light 668 is beneficial to increase the detection of substances located in the region 889 outside of the typical gaussian spot 888.

Turning to FIG. 9, an enlarged view of the sample 605 is again illustrated. In this configuration, the second light beam 672 forms a linear shape 982a on the sample 605. The linear shape 982a is any shape that deviates from the shape 780 of the collimated light 668, be it a polygon or round form, by elongating the shape 780 in one dimension to form the linear shape 982a. In the illustrated example, the linear shape 982a is an elliptical or ovular shape. The linear shape 982a defines a third area (denoted “A3”). The third area A3 is less than the second area A2 (A3<A2) and may define a minor axis, or beam width, (denoted “W”) that ranges from 30 micrometers (μm) to 40 μm. The width of the minor axis is limited by the focal length of the focusing component 632. The third area A3 may further define a major axis (denoted “L”) where the major axis L is less than or equal to the side dimension H times the square root of two (L=H√2). The length of the major axis is limited by the diameter D of the shape 780 of the collimated light 668.

In one non-limiting example, the third area A3 (the linear shape 982a) may be used when the sample 605 is a Surface-Enhanced Raman Spectroscopy (SERS) chip 984. As previously noted, the SERS chip 984 may have an uneven substrate distribution 986, and, thus, the second light beam 672 enables probing across a more geographically diverse region (e.g., the uneven substrate distribution 986 or otherwise non-uniform substance) of the sample 605 as compared to a typical gaussian spot 888, illustrated in dashed line in FIG. 8. In particular, by reshaping the collimated light 668 to the linear shape 982a, more of the second area A2 (or a more geographically diverse portion of the area A2) may be probed (e.g., enabling an overlap of the region 889 and the third area A3), which increases the detection of low-signal substances that may be distributed outside of the typical gaussian spot 888.

In some examples, in addition to using the linear shape to interrogate the third area A3 of the sample (e.g., the SERS chip 984) and, optionally, overlap the region 889 of the sample 605, the linear shaped beam can be rotated (e.g., approximately 0° to 180°) around a point R to probe (e.g., scan or sweep) additional regions or portions of the sample 605. For example, in the event the region 889 is located in the upper left-hand corner as illustrated by region 989, the second light beam 673 may be rotated approximately 90 degrees resulting in movement of the linear shape 982a to the linear shape 982b that effectively overlaps the region 989 (e.g., without requiring adjustments to the position of the sample, the probe, etc.). Similarly, the linear shaped beam can be rotated approximately 180° to effectively sweep the sample 605 (e.g., the entire SERS chip 984). Rotating the linear shaped beam can be performed via one more power actuators, manual movements, or the like and can involve rotating the entire attachment (e.g., around the circular probe), which is inexpensive to implement and results in a more accurate Raman signal by providing a more complete picture of the sample being analyzed.

It should be understood that the attachment 402 described herein is not limited to use with SERS chips but rather may be used in various environments with uneven surfaces or substances. For example, a linear shaped incident signal may be used in an overly turbulent or non-uniformly turbulent environment, such as, for example, a submersible environment. For example, in the event a piece of sediment is blocking a portion of the collimated light, or the first light beam, or the second light beam, using the linear shape 982a, 982b described herein rather than the gaussian spot 788 allows a Raman signal to be captured regardless of the sediment.

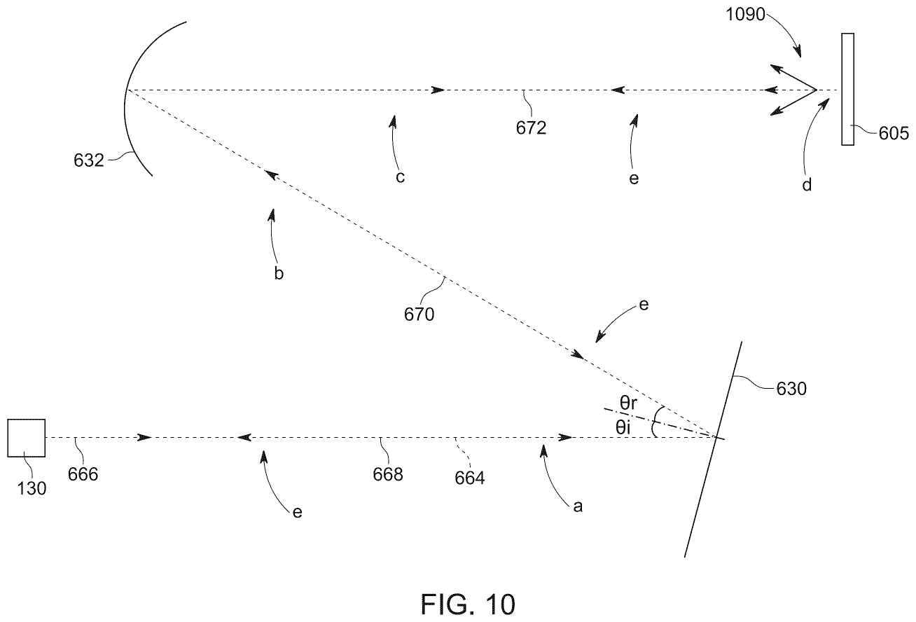

FIG. 10 illustrates a ray diagram of the path of light along the zigzag pathway 664 defined by the attachment 402. As illustrated in FIG. 10, the collimated light 668 travels toward (denoted “a”) the optical component 630 at an incident angle (denoted “θᵢ”). The collimated light 668 is then reflected at a reflection angle (denoted “θᵣ”) as the first light beam 670 that travels toward (denoted “b”) the concave mirror 132a. The first light beam 670 is then reflected (again at an incident/reflection angle not illustrated) and focused into a second light beam 672 that travels toward (denoted “c”) the sample 605. While the angles illustrated herein are acute angles, it should be understood that the angles can be any angle. In one example, the incident/reflection angle θᵢ/θᵣ ranges from 10° to 35°.

The second light beam 672 interrogates (denoted “d”) the sample 105 to emit a Raman signal light 1090 (e.g., effectively “glow”). The Raman signal light 1090, also referred to as Raman shifted light or emitted light (denoted “e”), travels back along the same zigzag pathway 664 toward a surface of the probe head 130 where the original excitation light 666 was emitted from. As noted above, the Raman signal light 1090 is directed toward the light analyzer 344 (FIG. 3) along the zigzag pathway 664. It should be understood that, in some examples, the detector may be positioned at various positions with respect to the attachment 402 and, thus, Raman shifted light detected by the detector may travel along a different optical path than the original excitation light 666.

While the attachment 402 described herein may be a separate accessory configured to be removably coupled to the probe component 104, in other examples, the attachment 402 may be formed with the probe component 104 such that the attachment 402 is not configured to be removed. However, in other examples, the attachment 402 may be removably attachable from the probe component 104 and capable of being integrated with existing spectroscopy workflows.

As noted above, benefits associated with a completely reflective system as described herein with regards to the optics housing include a low-cost solution to field-based devices. Further, with the optics housing described herein, rastering is not necessary as the linear shape received at the sample provides an effective and simple solution for proving a more geographically diverse region of the sample without mechanical movement. Further, optical properties with regard to air vs. fluids in which the housing may be submerged do not change. This makes the housing interchangeable in several fluids without a change in incoming spot size.

Accordingly, examples described herein provide for receiving both Raman signal light from a more geographically diverse region of the sample, thereby receiving an improved Raman signal light. Improved signal quality enables users of the optical analysis system to obtain more accurate and reliable data for monitoring parameters of the sample.

As described above in the detailed description, reference is made to the accompanying drawings that form a part hereof wherein like numerals designate like parts throughout, and in which is shown, by way of illustration, implementations that may be practiced. It is to be understood that other implementations may be utilized, and structured or logical changes may be made, without departing from the scope of the present disclosure. Therefore, the detailed description as described above is not to be taken in a limiting sense.

Various operations may be described as multiple discrete actions or operations in turn, in a manner that is most helpful in understanding the subject matter disclosed herein. However, the order of description should be construed as to imply that these operations are necessarily order dependent. In particular, these operations may not be performed in the order of presentation. Operations described may be performed in a different order from the described implementation. Various additional operations may be performed, and/or described operations may be omitted in additional implementations.

### Clauses

Implementations of the present disclosure are disclosed in the following clauses:
Clause 1. An optical analysis system for obtaining a Raman signal from a sample, the optical analysis system comprising: a light source generating an excitation light, wherein the excitation light is collimated light; an optical component configured to redirect the excitation light as a first light beam; and a focusing component configured to redirect the first light beam as a second light beam wherein the second light beam interrogates the sample at a predetermined distance from the focusing component in a linear shape.
Clause 2. The optical analysis system of clause 1, wherein the linear shape is an elliptical or ovular shape.
Clause 3. The optical analysis system of clause 2, wherein the first light beam has a circular shape.
Clause 4. The optical analysis system of clause 1, wherein the optical component is a flat mirror.
Clause 5. The optical analysis system of clause 1, wherein the focusing component is a cylindrical mirror.
Clause 6. The optical analysis system of clause 1, wherein the focusing component is a concave mirror.
Clause 7. The optical analysis system of clause 1, wherein the second light beam is rotatable about a point.
Clause 8. The optical analysis system of clause 1, wherein the first light beam is redirected at a first angle with respect to a first surface of the optical component.
Clause 9. The optical analysis system of clause 8, wherein the first angle ranges from 10° to 35°.
Clause 10. The optical analysis system of clause 1, wherein a cross-section of the collimated light has a diameter ranging from 2 mm to 20 mm.
Clause 11. The optical analysis system of clause 10, wherein the diameter is 4 mm.
Clause 12. The optical analysis system of clause 1, wherein the linear shape has a beam width ranging from 30 μm to 40 μm.
Clause 13. The optical analysis system of clause 1, wherein at least one of the optical component and the focusing component is covered at least partially with a coating.
Clause 14. The optical analysis system of clause 13, wherein the coating is a metal coating.
Clause 15. The optical analysis system of clause 14, wherein the metal coating is autoclavable.
Clause 16. The optical analysis system of clause 1, further comprising a light analyzer configured to receive a Raman signal emitted by the sample in response to the second light beam.
Clause 17. The optical analysis system of clause 1, further comprising an optics housing comprising a first part and a second part, wherein the first part includes the optical component, and the second part includes the focusing component.
Clause 18. The optical analysis system of clause 17, further comprising a probe component separate from the optics housing, wherein the light source is supported within the probe component.
Clause 19. The optical analysis system of clause 18, wherein the optics housing comprises an opening for receiving the excitation light from the light source.
Clause 20. The optical analysis system of clause 19, wherein the optics housing is configured to be coupled to the probe component.
Clause 21. The optical analysis system of clause 18, wherein the optics housing comprises a window and a gasket, the second light beam passing through the window to interrogate the sample.
Clause 22. The optical analysis system of clause 1, wherein the focusing component is configured to reflect and redirect a Raman light signal emitted by the sample as a second collimated light.
Clause 23. The optical analysis system of clause 22, wherein the optical component is configured to receive and redirect the second collimated light to the light source.
Clause 24. The optical analysis system of clause 1, wherein the sample is situated on a SERS chip.
Clause 25. An attachment for an optical analysis system for obtaining a Raman signal from a sample, the attachment comprising: an optics housing including a first opening for receiving an excitation light from a light source, wherein the optics housing defines a pathway; an optical component positioned within the optics housing and configured to receive the excitation light as a collimated light and redirect the collimated light along the pathway as a first light beam; and a focusing component positioned within the optics housing and configured to receive the first light beam and redirect the first light beam as a second light beam along the pathway toward the sample, the second light beam having a linear shape, the optics housing further including a second opening, the second light beam passing through the second opening to interrogate to the sample.
Clause 26. The attachment of clause 25, wherein the optical component is a flat mirror.
Clause 27. The attachment of clause 25, wherein the focusing component is a concave mirror.
Clause 28. The attachment of clause 25, wherein the second opening includes a gasket and a window.

What is claimed is:

1. An optical analysis system for obtaining a Raman signal from a sample, the optical analysis system comprising:
a light source generating an excitation light, wherein the excitation light is collimated light;
an optical component configured to redirect the excitation light as a first light beam; and
a focusing component configured to redirect the first light beam as a second light beam wherein the second light beam interrogates the sample at a predetermined distance from the focusing component in a linear shape.

2. The optical analysis system of claim 1, wherein the linear shape is an elliptical or ovular shape.

3. The optical analysis system of claim 2, wherein the first light beam has a circular shape.

4. The optical analysis system of claim 1, wherein the optical component is a flat mirror.

5. The optical analysis system of claim 1, wherein the focusing component is a cylindrical mirror.

6. The optical analysis system of claim 1, wherein the focusing component is a concave mirror.

7. (canceled)

8. The optical analysis system of claim 1, wherein the first light beam is redirected at a first angle with respect to a first surface of the optical component.

9. The optical analysis system of claim 8, wherein the first angle ranges from 10° to 35°.

10. The optical analysis system of claim 1, wherein a cross-section of the collimated light has a diameter ranging from 2 mm to 20 mm.

11. (canceled)

12. The optical analysis system of claim 1, wherein the linear shape has a beam width ranging from 30 μm to 40 μm.

13. The optical analysis system of claim 1, wherein at least one of the optical component and the focusing component is covered at least partially with a coating.

14. (canceled)

15. (canceled)

16. The optical analysis system of claim 1, further comprising a light analyzer configured to receive a Raman signal emitted by the sample in response to the second light beam.

17. The optical analysis system of claim 1, further comprising an optics housing comprising a first part and a second part, wherein the first part includes the optical component, and the second part includes the focusing component.

18. The optical analysis system of claim 17, further comprising a probe component separate from the optics housing, wherein the light source is supported within the probe component.

19. The optical analysis system of claim 18, wherein the optics housing comprises an opening for receiving the excitation light from the light source.

20. The optical analysis system of claim 19, wherein the optics housing is configured to be coupled to the probe component.

21. The optical analysis system of claim 18, wherein the optics housing comprises a window and a gasket, the second light beam passing through the window to interrogate the sample.

22. The optical analysis system of claim 1, wherein the focusing component is configured to reflect and redirect a Raman light signal emitted by the sample as a second collimated light.

23. The optical analysis system of claim 22, wherein the optical component is configured to receive and redirect the second collimated light to the light source.

24. (canceled)

25. An attachment for an optical analysis system for obtaining a Raman signal from a sample, the attachment comprising:
an optics housing including a first opening for receiving an excitation light from a light source, wherein the optics housing defines a pathway;
an optical component positioned within the optics housing and configured to receive the excitation light as a collimated light and redirect the collimated light along the pathway as a first light beam; and
a focusing component positioned within the optics housing and configured to receive the first light beam and redirect the first light beam as a second light beam along the pathway toward the sample, the second light beam having a linear shape,
the optics housing further including a second opening, the second light beam passing through the second opening to interrogate to the sample.

26-28. (canceled)
